(19) United States
(12) Patent Application Publication
(10) Pub. No.: US 2016/0293294 A1
(43) Pub. Date: Oct. 6, 2016

(54) CABLE FOR DOWNHOLE EQUIPMENT

(71) Applicant: SCHLUMBERGER TECHNOLOGY CORPORATION, Sugar Land, TX (US)

(72) Inventors: Bradley Matlack, Shawnee, KS (US); Jason Holzmueller, Lawrence, KS (US); Brandon Neal, Lawrence, KS (US); Mark Metzger, Lawrence, KS (US)

(21) Appl. No.: 15/037,977

(22) PCT Filed: Nov. 18, 2014
(86) PCT No.: PCT/US2014/066075

§ 371 Date: May 19, 2016

Related U.S. Application Data
(60) Provisional application No. 61/906,806, filed on Nov. 20, 2013.

(51) Int. Cl. H01B 7/42; E21B 43/12; H01B 3/44; H01B 7/08; H01B 7/02; E21B 17/00; E21B 47/00

(52) U.S. Cl. CPC H01B 7/421; E21B 17/003; E21B 43/128; E21B 47/0007; H01B 7/08; H01B 7/0216; H01B 3/445; E21B 47/065

(57) ABSTRACT

An electric submersible pump system can include a shaft; a power cable connector for receipt of multiphase power; a multiphase electric motor configured to receive power via the power cable connector for rotatably driving the shaft; a pump operatively coupled to the shaft; and a power cable that includes a connector for connection to the power cable connector, a row multiphase conductors, a jacket surrounding the row of multiphase conductors that includes a polymer, and an outer coating that includes a fluoropolymer.

### RELATED APPLICATIONS

This application claims priority to and the benefit of a U.S. Provisional Application having Serial No. 61/906,806, filed 20 Nov. 2013, which is incorporated by reference herein.

### BACKGROUND

An electric submersible pump (ESP) system can include a pump driven by an electric motor. As an example, an ESP system may be deployed in a well, for example, to pump fluid. Such an ESP system may be operatively coupled to a cable that can supply power to an electric motor, allow for transmission of information, etc. Such a cable may be exposed to harsh environmental and operational conditions.

### SUMMARY

An electric submersible pump system can include a shaft; a power cable connector for receipt of multiphase power; a multiphase electric motor configured to receive power via the power cable connector for rotatably driving the shaft; a pump operatively coupled to the shaft; and a power cable that includes a connector for connection to the power cable connector, a row multiphase conductors, a jacket surrounding the row of multiphase conductors that includes a polymer, and an outer coating that includes a fluoropolymer. A power cable can include a major axis dimension and a minor axis dimension; a minor axis dimension to major axis dimension ratio in a range of 2 to 1 to 5 to 1; multiphase conductors spaced along the major axis dimension; a jacket surrounding the multiphase conductors that includes a polymer; and an outer coating that includes a fluoropolymer. A method can include providing an electric submersible pump system in a downhole environment where the electric submersible pump system includes a shaft; a power cable connector for receipt of multiphase power; a multiphase electric motor that receives power via the power cable connector for rotatably driving the shaft; a pump operatively coupled to the shaft; and a power cable connected to the power cable connector where the power cable includes a row of multiphase conductors, a jacket surrounding the row of multiphase conductors that includes a polymer, and an outer coating that includes a fluoropolymer; supplying multiphase power to the power cable to energize the multiphase electric motor to thereby pump downhole fluid from the downhole environment to a surface environment; generating heat energy in the row of multiphase conductors responsive to the supplying of multiphase power; dissipating heat energy from the row of multiphase conductors via the jacket; and removing at least the power cable from the downhole environment to the surface environment without entraining downhole fluid in the power cable. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates examples of equipment in geologic environments;

FIG. 2 illustrates an example of an electric submersible pump system;

FIG. 3 illustrates examples of equipment;

FIG. 4 illustrates an example of a system that includes a motor;

FIG. 5 illustrates an example of a cable;

FIG. 6 illustrates an example of a plot;

FIG. 7 illustrates an example of a cable;

FIG. 8 illustrates examples of methods;

FIG. 9 illustrates an example of a cable;

FIG. 10 illustrates examples of plots;

FIG. 11 illustrates examples of cables; and

FIG. 12 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

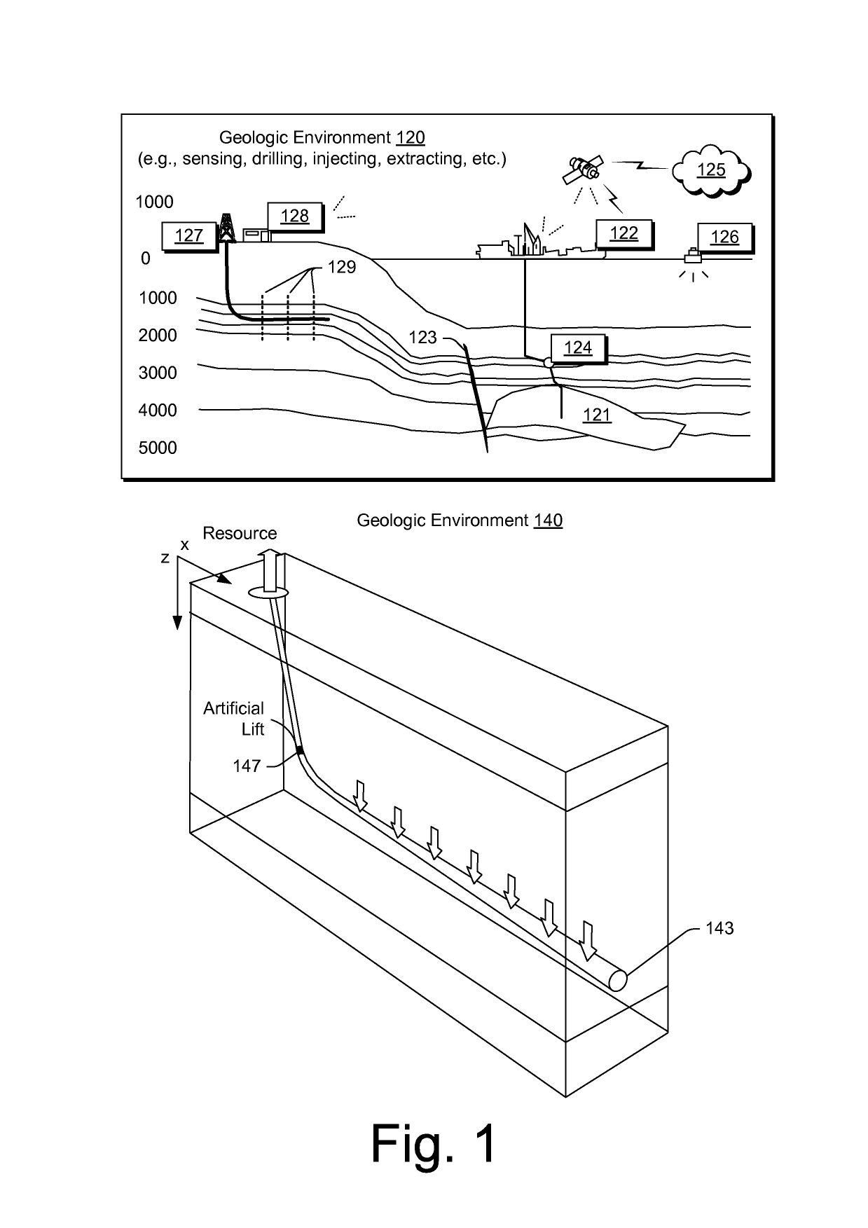

FIG. 1 shows examples of geologic environments 120 and 140. In FIG. 1, the geologic environment 120 may be a sedimentary basin that includes layers (e.g., stratification) that include a reservoir 121 and that may be, for example, intersected by a fault 123 (e.g., or faults). As an example, the geologic environment 120 may be outfitted with any of a variety of sensors, detectors, actuators, etc. For example, equipment 122 may include communication circuitry to receive and to transmit information with respect to one or more networks 125. Such information may include information associated with downhole equipment 124, which may be equipment to acquire information, to assist with resource recovery, etc. Other equipment 126 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 125 that may be configured for communications, noting that the satellite may additionally or alternatively include circuitry for imagery (e.g., spatial, spectral, temporal, radiometric, etc.).

FIG. 1 also shows the geologic environment 120 as optionally including equipment 127 and 128 associated with a well that includes a substantially horizontal portion that may intersect with one or more fractures 129. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop the reservoir (e.g., via fracturing, injecting, extracting, etc.). As an example, the equipment 127 and/or 128 may include components, a system, systems, etc. for fracturing, seismic sensing, analysis of seismic data, assessment of one or more fractures, etc.

As to the geologic environment 140, as shown in FIG. 1, it includes a well 141 (e.g., a bore) and equipment 147 for artificial lift, which may be an electric submersible pump (e.g., an ESP). In such an example, a cable or cables may extend from surface equipment to the equipment 147, for example, to provide power, to carry information, to sense information, etc.

Conditions in a geologic environment may be transient and/or persistent. Where equipment is placed within a geologic environment, longevity of the equipment can depend on characteristics of the environment and, for example, duration of use of the equipment as well as function of the equipment. Where equipment is to endure in an environment over an extended period of time, uncertainty may arise in one or more factors that could impact integrity or expected lifetime of the equipment. As an example, where a period of time may be of the order of decades, equipment that is intended to last for such a period of time may be constructed to endure conditions imposed thereon, whether imposed by an environment or environments and/or one or more functions of the equipment itself.

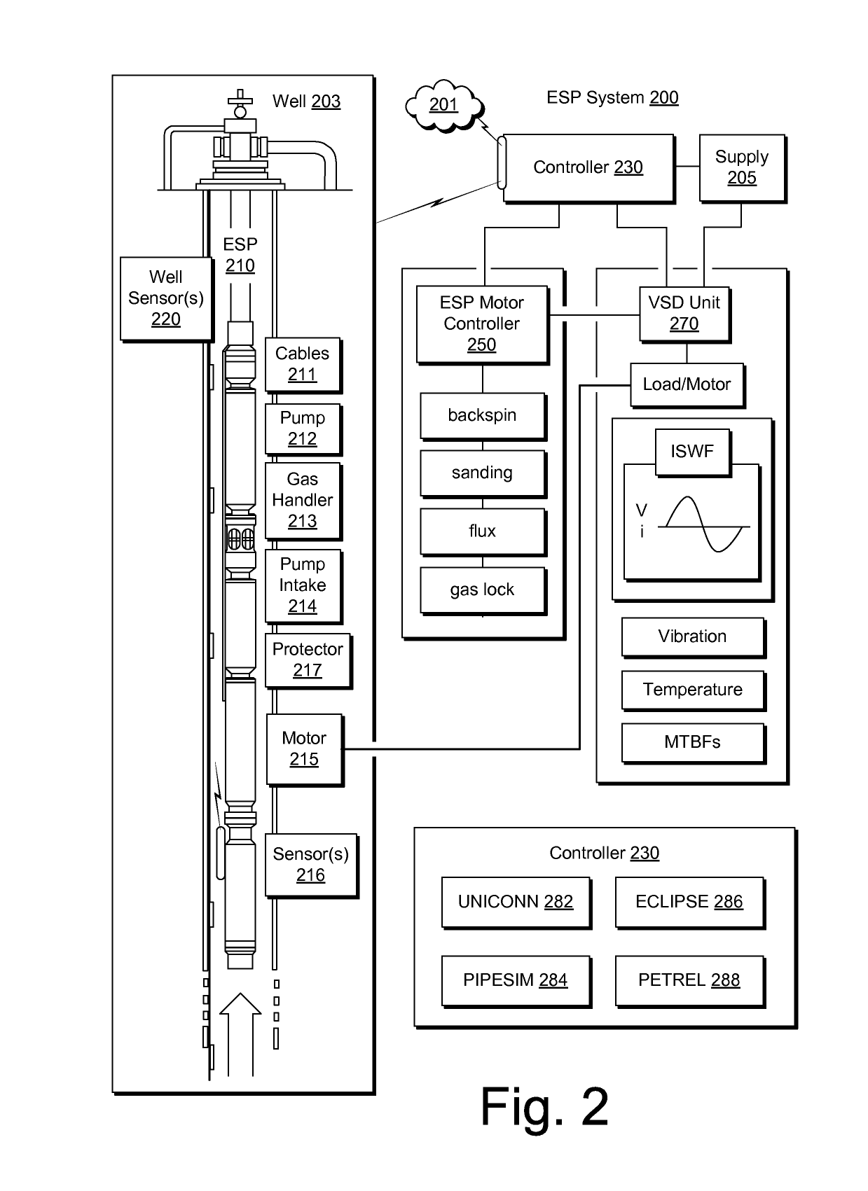

FIG. 2 shows an example of an ESP system 200 that includes an ESP 210 as an example of equipment that may be placed in a geologic environment. As an example, an ESP may be expected to function in an environment over an extended period of time (e.g., optionally of the order of years).

In the example of FIG. 2, the ESP system 200 includes a network 201, a well 203 disposed in a geologic environment (e.g., with surface equipment, etc.), a power supply 205, the ESP 210, a controller 230, a motor controller 250 and a VSD unit 270. The power supply 205 may receive power from a power grid, an onsite generator (e.g., natural gas driven turbine), or other source. The power supply 205 may supply a voltage, for example, of about 4.16 kV.

As shown, the well 203 includes a wellhead that can include a choke (e.g., a choke valve). For example, the well 203 can include a choke valve to control various operations such as to reduce pressure of a fluid from high pressure in a closed wellbore to atmospheric pressure. A wellhead may include one or more sensors such as a temperature sensor, a pressure sensor, a solids sensor, etc.

As to the ESP 210, it is shown as including cables 211 (e.g., or a cable), a pump 212, gas handling features 213, a pump intake 214, a motor 215, one or more sensors 216 (e.g., temperature, pressure, strain, current leakage, vibration, etc.) and a protector 217.

As an example, an ESP may include a REDA™ HOTLINE™ high-temperature ESP motor. Such a motor may be suitable for implementation in a thermal recovery heavy oil production system, such as, for example, SAGD system or other steam-flooding system.

As an example, an ESP motor can include a three-phase squirrel cage with two-pole induction. As an example, an ESP motor may include steel stator laminations that can help focus magnetic forces on rotors, for example, to help reduce energy loss. As an example, stator windings can include copper and insulation.

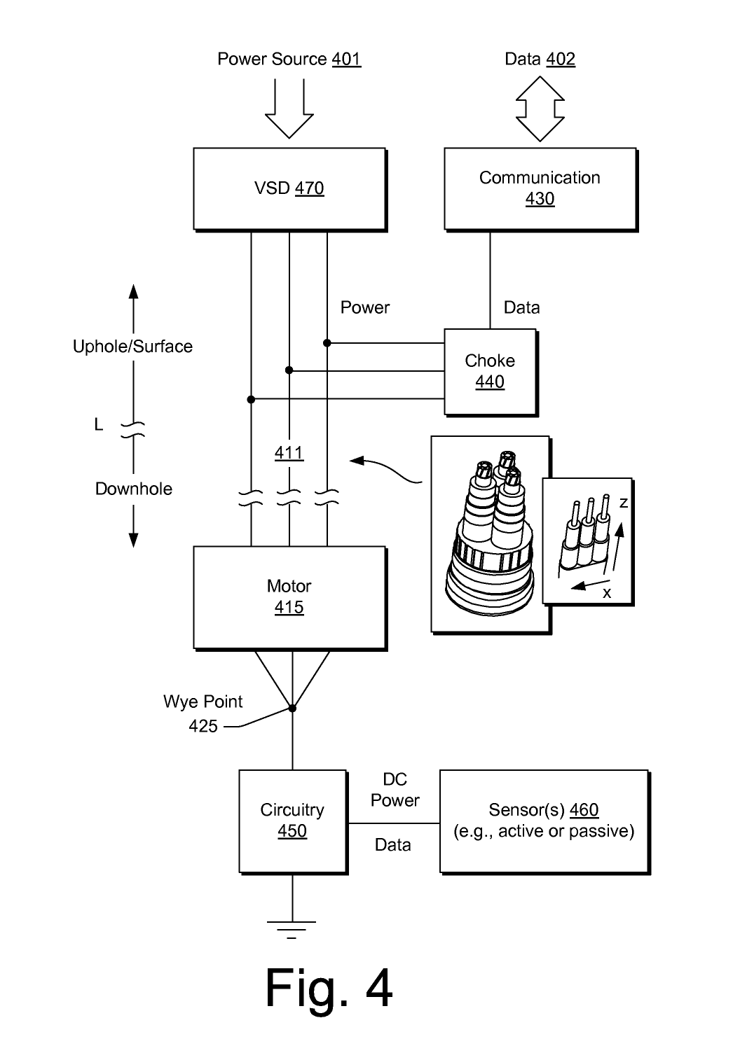

As an example, the one or more sensors 216 of the ESP 210 may be part of a digital downhole monitoring system. For example, consider the commercially available PHOENIX™ MULTISENSOR XT150 system marketed by Schlumberger Limited (Houston, Tex.). A monitoring system may include a base unit that operatively couples to an ESP motor (see, e.g., the motor 215), for example, directly, via a motor-base crossover, etc. As an example, such a base unit (e.g., base gauge) may measure intake pressure, intake temperature, motor oil temperature, motor winding temperature, vibration, currently leakage, etc. As explained with respect to FIG. 4, a base unit may transmit information via a power cable that provides power to an ESP motor and may receive power via such a cable as well.

As an example, a remote unit may be provided that may be located at a pump discharge (e.g., located at an end opposite the pump intake 214). As an example, a base unit and a remote unit may, in combination, measure intake and discharge pressures across a pump (see, e.g., the pump 212), for example, for analysis of a pump curve. As an example, alarms may be set for one or more parameters (e.g., measurements, parameters based on measurements, etc.).

Where a system includes a base unit and a remote unit, such as those of the PHOENIX™ MULTISENSOR XT150 system, the units may be linked via wires. Such an arrangement provide power from the base unit to the remote unit and allows for communication between the base unit and the remote unit (e.g., at least transmission of information from the remote unit to the base unit). As an example, a remote unit is powered via a wired interface to a base unit such that one or more sensors of the remote unit can sense physical phenomena. In such an example, the remote unit can then transmit sensed information to the base unit, which, in turn, may transmit such information to a surface unit via a power cable configured to provide power to an ESP motor.

In the example of FIG. 2, the well 203 may include one or more well sensors 220, for example, such as the commercially available OPTICLINE™ sensors or WELLWATCHER BRITEBLUE™ sensors marketed by Schlumberger Limited (Houston, Tex.). Such sensors are fiber-optic based and can provide for real time sensing of temperature, for example, in SAGD or other operations. As shown in the example of FIG. 1, a well can include a relatively horizontal portion. Such a portion may collect heated heavy oil responsive to steam injection. Measurements of temperature along the length of the well can provide for feedback, for example, to understand conditions downhole of an ESP. Well sensors may extend a considerable distance into a well and possibly beyond a position of an ESP.

In the example of FIG. 2, the controller 230 can include one or more interfaces, for example, for receipt, transmission or receipt and transmission of information with the motor controller 250, a VSD unit 270, the power supply 205 (e.g., a gas fueled turbine generator, a power company, etc.), the network 201, equipment in the well 203, equipment in another well, etc.

As shown in FIG. 2, the controller 230 may include or provide access to one or more modules or frameworks. Further, the controller 230 may include features of an ESP motor controller and optionally supplant the ESP motor controller 250. For example, the controller 230 may include the UNICONN™ motor controller 282 marketed by Schlumberger Limited (Houston, Tex.). In the example of FIG. 2, the controller 230 may access one or more of the PIPESIM™ framework 284, the ECLIPSE™ framework 286 marketed by Schlumberger Limited (Houston, Tex.) and the PETREL™ framework 288 marketed by Schlumberger Limited (Houston, Tex.) (e.g., and optionally the OCEAN™ framework marketed by Schlumberger Limited (Houston, Tex.)).

In the example of FIG. 2, the motor controller 250 may be a commercially available motor controller such as the UNICONN™ motor controller. The UNICONN™ motor controller can connect to a SCADA system, the ESPWATCHER™ surveillance system, etc. The UNICONN™ motor controller can perform some control and data acquisition tasks for ESPs, surface pumps or other monitored wells. As an example, the UNICONN™ motor controller can interface with the aforementioned PHOENIX™ monitoring system, for example, to access pressure, temperature and vibration data and various protection parameters as well as to provide direct current power to downhole sensors. The UNICONN™ motor controller can interface with fixed speed drive (FSD) controllers or a VSD unit, for example, such as the VSD unit 270.

For FSD controllers, the UNICONN™ motor controller can monitor ESP system three-phase currents, three-phase surface voltage, supply voltage and frequency, ESP spinning frequency and leg ground, power factor and motor load.

For VSD units, the UNICONN™ motor controller can monitor VSD output current, ESP running current, VSD output voltage, supply voltage, VSD input and VSD output power, VSD output frequency, drive loading, motor load, three-phase ESP running current, three-phase VSD input or output voltage, ESP spinning frequency, and leg-ground.

In the example of FIG. 2, the ESP motor controller 250 includes various modules to handle, for example, backspin of an ESP, sanding of an ESP, flux of an ESP and gas lock of an ESP. The motor controller 250 may include any of a variety of features, additionally, alternatively, etc.

In the example of FIG. 2, the VSD unit 270 may be a low voltage drive (LVD) unit, a medium voltage drive (MVD) unit or other type of unit (e.g., a high voltage drive, which may provide a voltage in excess of about 4.16 kV). As an example, the VSD unit 270 may receive power with a voltage of about 4.16 kV and control a motor as a load with a voltage from about 0 V to about 4.16 kV. The VSD unit 270 may include commercially available control circuitry such as the SPEEDSTAR™ MVD control circuitry marketed by Schlumberger Limited (Houston, Tex.).

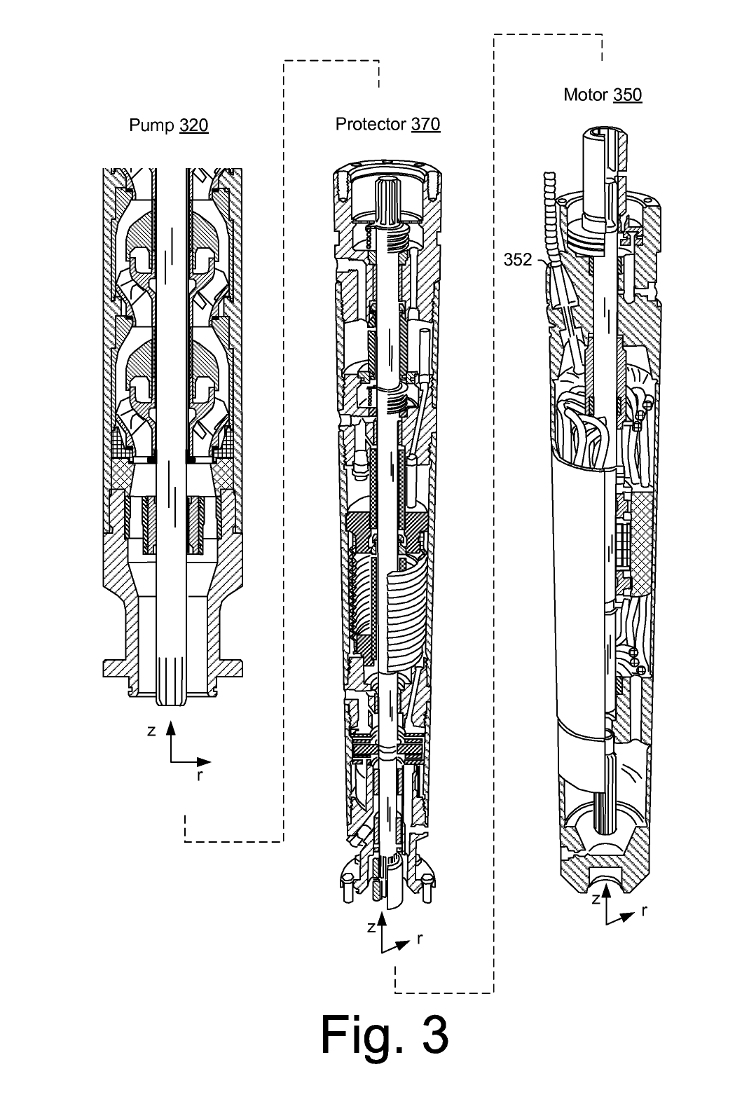

FIG. 3 shows cut-away views of examples of equipment such as, for example, a portion of a pump 320, a protector 370 and a motor 350 of an ESP. The pump 320, the protector 370 and the motor 350 are shown with respect to cylindrical coordinate systems (e.g., r, z, Θ). Various features of equipment may be described, defined, etc. with respect to a cylindrical coordinate system. As an example, a lower end of the pump 320 may be coupled to an upper end of the protector 370 and a lower end of the protector 370 may be coupled to an upper end of the motor 350. As shown in FIG. 3, a shaft segment of the pump 320 may be coupled via a connector to a shaft segment of the protector 370 and the shaft segment of the protector 370 may be coupled via a connector to a shaft segment of the motor 350. As an example, an ESP may be oriented in a desired direction, which may be vertical, horizontal or other angle. As shown in FIG. 3, the motor 350 is an electric motor that includes a connector 352, for example, to operatively couple the electric motor to a power cable, for example, optionally via one or more motor lead extensions (see, e.g., FIG. 4).

FIG. 4 shows a block diagram of an example of a system 400 that includes a power source 401 as well as data 402 (e.g., information). The power source 401 provides power to a VSD block 470 while the data 402 may be provided to a communication block 430. The data 402 may include instructions, for example, to instruct circuitry of the circuitry block 450, one or more sensors of the sensor block 460, etc. The data 402 may be or include data communicated, for example, from the circuitry block 450, the sensor block 460, etc. In the example of FIG. 4, a choke block 440 can provide for transmission of data signals via a power cable 411 (e.g., including motor lead extensions “MLEs”). A power cable may be provided in a format such as a round format or a flat format with multiple conductors. MLEs may be spliced onto a power cable to allow each of the conductors to physically connect to an appropriate corresponding connector of an electric motor (see, e.g., the connector 352 of FIG. 3). As an example, MLEs may be bundled within an outer casing (e.g., a layer of armor, etc.).

As shown, the power cable 411 connects to a motor block 415, which may be a motor (or motors) of an ESP and be controllable via the VSD block 470. In the example of FIG. 4, the conductors of the power cable 411 electrically connect at a wye point 425. The circuitry block 450 may derive power via the wye point 425 and may optionally transmit, receive or transmit and receive data via the wye point 425. As shown, the circuitry block 450 may be grounded.

As an example, power cables and MLEs that can resist damaging forces, whether mechanical, electrical or chemical, may help ensure proper operation of a motor, circuitry, sensors, etc.; noting that a faulty power cable (or MLE) can potentially damage a motor, circuitry, sensors, etc. Further, as mentioned, an ESP may be located several kilometers into a wellbore. Accordingly, time and cost to replace a faulty ESP, power cable, MLE, etc., can be substantial (e.g., time to withdraw, downtime for fluid pumping, time to insert, etc.).

As an example, a cable may allow for extended run life, low cost, and improved manufacturability. For example, a downhole power cable for electrical submersible pumps (ESP) may include various features, materials of construction, etc. that may improve reliability and reduce environmental impact (e.g., during use, after use, etc.).

As an example, a cable may be rated. For example, ESP cables may be rated by voltage such as about 3 kV, about 4 kV or about 5 kV. As to form, a round cable may be implemented in boreholes where sufficient room exists and a so-called “flat” cable may be implemented where less room may be available (e.g., to provide clearance, etc.).

As an example, a round ESP cable rated to about 5 kV may include a copper conductor(s), oil and heat resistant ethylene propylene diene monomer (M-class) rubber insulation (EPDM insulation), a barrier layer (e.g., lead and/or fluoropolymer or without a barrier layer), a jacket layer (e.g., oil resistant EPDM or nitrile rubber), and armor (e.g., galvanized or stainless steel or alloys that include nickel and copper such as MONEL™ alloys, Huntington Alloys Corporation, Huntington, W. Va.).

As an example, a flat ESP cable rated to about 5 kV may include a copper conductor(s), oil and heat resistant EPDM rubber insulation, a barrier layer (e.g., lead and/or fluoropolymer or without a barrier layer), a jacket layer (e.g., oil resistant EPDM or nitrile rubber or without a jacket layer), and armor (e.g., galvanized or stainless steel or alloys that include nickel and copper such as MONEL™ alloys).

In the foregoing examples, armor on the outside of a cable acts to protect the cable from damage, for example, from handling during transport, equipment installation, and equipment removal from the wellbore. Additionally, armor can help to prevent an underlying jacket, barrier, and insulation layers from swelling and abrasion during operation. In such examples, as armor is formed out of metallic strips and wrapped around the cable, voids exist between the overlapping armor layers which can collect well fluid after the cable has been installed in a wellbore. In such scenarios, when the cable is removed from the wellbore the well fluid tends to remain trapped in voids and therefore can cause environmental damage as it drips off of the cable during transport and recycling. Further, as an example, if armor is not present, well fluid can become trapped inside a jacket layer and, for example, lead to environmental challenging situations when the cable is removed from a wellbore.

As an example, a cable can reduce environmental impact via a reduction of features that may pose potential risks for well fluid (e.g., oil, etc.) to be trapped inside the cable. For example, such a cable can include a durable polymeric coating over an armor layer (e.g., or a jacket layer) to help prevent well fluid from becoming trapped between overlapping armor layers (e.g., or inside the jacket if the cable does not have armor). In such an example, the polymeric coating may be an outermost layer that is smooth (e.g., without ridges, etc. as may be formed by overlying metal strips of armor).

As an example, a layer disposed over an armor layer (e.g., over an outer surface of an armor layer) may be of sufficient robustness to reduce risk of damage, for example, during installation. In such an example, the layer may be resistant to abrasion from well fluid.

As an example, a flat cable may be subject to heating effects, for example, consider a center conductor proximate to neighboring conductors (e.g., consider two neighboring conductors) that may act to diminish heat transfer from the center conductor to a region outside of the flat cable. In such an example, the increased temperature on the center conductor can create an increase electrical resistance and therefore can lead to a phase imbalance in the power supplied downhole for long lengths of cable. As an example, a cable may improve reliability by modifying a nitrile material to dissipate heat more effectively and therefore reduce the heating on a center conductor (e.g., a “middle” conductor). For example, a cable may include a composite material of a nitrile material and one or more fillers where the one or more fillers increase thermal conductivity (e.g., where the one or more fillers have a thermal conductivity greater than the nitrile material by itself).

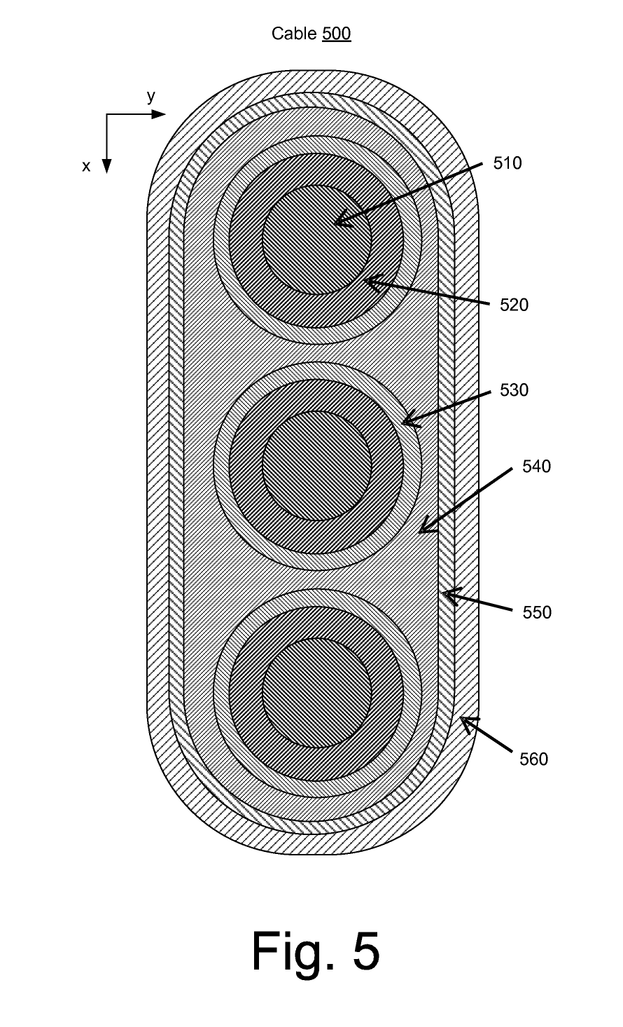

FIG. 5 shows an example of a cable 500 that includes various components. For example, the cable 500 can include conductors 510, conductor shields (e.g., which may be optional), insulation 520, insulation shields (optional), conductive layers (e.g., which may be optional), barrier layers 530 (e.g., which may be optional), a cable jacket 540, cable armor 550 (e.g., which may be optional) and an outer coating 560 (e.g., an outermost coating or layer).

Conductors 510

In the example of FIG. 5, three conductors 510 are shown as being arranged as a first conductor, a second conductor and a third conductor where the second conductor is disposed between the first conductor and the third conductor. As an example, a cable conductor may be made of copper (e.g., high purity) and may be solid, stranded or compacted stranded. Stranded and compacted stranded conductors may offer improved flexibility and may be selected depending on installation (e.g., environment, bore deviation, etc.). As an example, a conductor may be coated with a corrosion resistant coating, for example, to help prevent conductor degradation from hydrogen sulfide gas which may be present in a downhole environment. Examples of such a coating may include tin, lead, nickel, silver or other corrosion resistant alloy or metal.

Conductor Shield (e.g., optional)

As an example, a conductor shield may be a semiconductive layer disposed around a conductor. In such an example, the conductor shield may help to control electrical stress in a cable, for example, to minimize discharge. As an example, a conductor shield, as a layer, may be in a range from about 0.002 inch to about 0.020 inch (e.g., about 0.05 mm to about 0.5 mm). As an example, a conductor shield may be bonded to a conductor and, for example, to insulation to help to prevent gas migration. As an example, a conductor shield may be strippable, for example, to allow for access to a conductor (e.g., for purposes of fitting, connectors, splicing, etc.). Whether or not a conductor shield is bonded may depend on its intended application.

As an example, a conductor shield may include semiconductive tape wrap and/or extruded semiconductive polymer. As an example, a conductor shield may be an elastomer or thermoplastic co-extruded with the insulation allowing the layers to crosslink together. As an example, co-extrusion may help to reduce risk of voids, for example, at the conductor shield-insulation interface.

Material used for a conductor shield may be, as an example, semiconductive (e.g., defined as having a resistivity less than about 5000 ohm-cm). As an example, an elastomer (e.g., EPDM) compound loaded with conductive fillers may be used as a conductor shield material. As an example, a polyether ether ketone (PEEK) compound that includes conductive fillers may be used as a conductor shield material. As an example, an insulation shield and insulation do not have to use the same base material, although they may, for example, to facilitate processing.

Insulation 520

In the example of FIG. 5, each of the first, second and third conductors 510 includes a respective layer of insulation 520. As an example, a contiguous layer of insulation may be provided that encapsulates and insulates the conductors. As an example, a contiguous layer of insulation may insulate two conductors while a separate layer of insulation insulates another conductor.

As an example, insulation material may include EPDM and/or PEEK. As an example, where insulation material is EPDM, a compound formulation for oil and decompression resistance may be used.

As an example, an insulation layer may adhere to or be bonded to a conductor shield, for example, where a conductor shield is present. As an example, an insulation layer may be continuous with an insulation shield, for example, with complete bonding or without complete bonding thereto. As an example, where PEEK is selected as a material for an insulation layer, mechanical properties thereof may allow for improved damage resistance, for example, to resist damage to a cable during cable install, cable operation, cable repositioning, cable removal, etc. In such an example, PEEK can offer relatively high stiffness, which may allow for greater ease in sealing over a cable (e.g., cable members such as members that each include a conductor), for example, at a cable termination point or points (e.g., motor pothead, well connectors, feed-throughs, etc.). As an example, such an approach may improve cable and system reliability.

Insulation Shield (e.g., optional)

As an example, an insulation shield may be a semiconductive layer applied over insulation to help reduce (e.g., minimize) electrical stresses in a cable. As an example, an insulation shield may be bonded to insulation or, for example, may be configured with an amount of bonding that allows for ease of stripping (e.g., to be relatively strippable). As an example, some adhesion between layers may help to avoid voids, defects, etc. in a cable. As an example, an insulation shield material may be a semiconductive tape and/or a semiconductive polymer. As an example, akin to a conductor shield, an insulation shield may be co-extruded with insulation, for example, to help ensure more complete contact between surfaces (e.g., interface surfaces). As an example, material used for an insulation shield may be semiconductive (e.g., defined as having a resistivity less than about 5000 ohm-cm). As an example, insulation shield material may be used as conductor shield material. As an example, materials may differ for such layers, for example, to enhances stripability, processing, etc.

Conductive Layer (e.g., optional)

As an example, outside of an insulation shield, a conductive layer may optionally be applied, for example, to serve as a ground plane. Such a layer may serve to help isolate phases of a cable from each other (e.g., three phases or more than three phases). As an example, materials such as, for example, copper, aluminum, lead, or other conductive material tape, braid, paint, or extruded material, may be applied to provide a conductive layer. As an example, a conductive layer may serve as a barrier to downhole gas and fluids, for example, to help protect inner cable layers.

Barrier layer 530 (e.g., optional)

In the example of FIG. 5, the cable 500 is shown as including an optional barrier layer 530. As shown, each of the first, second and third conductors 510 includes a respective barrier layer 530. As an example, a cable may include a contiguous barrier layer, for example, that may surround more than one conductor.

As an example, a cable may include a barrier layer to help protect the cable from corrosive downhole gases and fluids. As an example, one or more additional barrier layers may be used, for example, depending on intended use, environmental conditions, etc. As an example, a barrier may be formed of extruded material, tape, etc. As an example, a barrier layer may include a fluoropolymer or fluoropolymers, lead, and/or other material (e.g., to help protect against well fluids, etc.). As an example, a combination of extruded and taped layers may be used.

Cable Jacket 540

In the example of FIG. 5, the cable 500 is shown as including a contiguous cable jacket 540 that jackets the first, second and third conductors 510 (e.g., including layers of the first, second and third conductors 510).

As an example, for a flat cable configuration (e.g., and for a round cable configuration where conductors may be twisted together), a fluid, gas and temperature resistant jacket may be used. Such a jacket may help protect a cable from damage, for example, in challenging downhole environments.

As an example, a cable jacket may include one or more layers of EPDM, nitrile, hydrogenated nitrile butadiene rubber (HNBR), fluoropolymer, chloroprene, and/or other material resistant to constituents, conditions, etc. in a downhole environment.

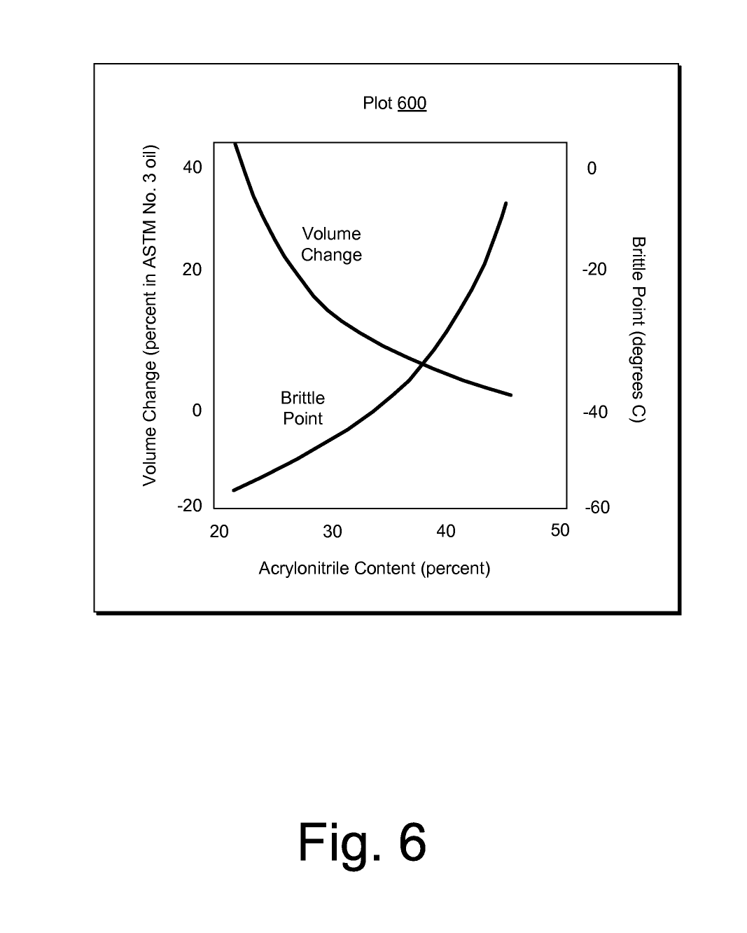

As an example, a jacket may be made of a fluid resistant nitrile elastomer, for example, with low swell ratings in water and in hydrocarbon oil and, for example, with appropriate resistance to wellbore gases (see, e.g., the plot 600 of FIG. 6).

As an example, low swell property of the jacket may act to reduce (e.g., minimize) an amount of well fluid that may possibly be absorbed into the cable. As an example, an elastomer jacket may help to prevent fluid migration into a cable and help to provide mechanical protection of insulated conductors set within the elastomer jacket (e.g., jacketed by the elastomer jacket).

As an example, an elastomer jacket may be compounded with fillers that provide for increased thermal conductivity, which may, for example, act to transport heat energy in a manner that can reduce heat buildup on a center conductor in the cable. For example, as to the cable 500, the cable jacket 540 may include a filler material that has a thermal conductivity that exceeds that of an elastomeric matrix. For example, nitrile butadiene rubber (NBR) may have a thermal conductivity of about 0.24 W/mK (e.g., consider natural rubber as having a thermal conductivity of about 0.13 W/mK to about 0.15 W/mK). As an example, a jacket that has a thermal conductivity, which may be directional, that is greater than about 0.24 W/mK may help to reduce heat buildup, for example, of a conductor that has two or more neighboring conductors within a cable (e.g., consider the first, second and third conductors 510 of the cable 500). In such an example, the cable may provide a more balanced voltage. In such an example, the cable may experience a reduction in heat aging of one or more dielectric materials (e.g., layers, etc.).

As an example, the jacket 540 may include a composite material that includes NBR and one or more fillers that increase the thermal conductivity beyond that of NBR. As an example, to achieve desired thermal properties, the jacket 540 may include HNBR and/or EPDM and optionally one or more additional materials. As an example, the jacket 540 may include PVDF (e.g., about 0.19 W/mK) and/or PEEK (e.g., about 0.25 W/mK), optionally with one or more additional materials, for example, to increase thermal conductivity, strength, etc. As an example, a jacket of a cable (e.g., the jacket 540) may have a thermal conductivity greater than about 0.25 W/mK and optionally greater than about 0.30 W/mK (e.g., via use of one or more fillers that form a composite material with one or more polymers).

As an example, a cable can include three conductors set in a row and a jacket disposed about the conductors where the jacket is made of a material that has a thermal conductivity, for example, greater than about 0.24 W/mK (e.g., consider a composite material that includes NBR and one or more fillers, etc.). In such an example, a middle conductor may experience a more uniform temperature-time profile with respect to its two neighboring conductors. In other words, the variation in temperature with respect to time for the three conductors may be more uniform due in part to the thermal conduction properties of the jacket. In such an example, the three conductors may be for delivery of three phase power to an electric motor. In such an example, the delivery of the power may cause each of the three conductors to generate heat energy (e.g., due to resistance, etc.). As properties of a conductive material may depend on temperature, differences in temperature of the three conductors (e.g., with respect to each other), may contribute to imbalance in delivery of the three phase power. For example, such imbalance (e.g., or unbalance) may be measured at a wye point of a three phase electric motor that coupled to the three conductors and driven by power supplied via the three conductors.

In the example of FIG. 5, the cable 500 has an oblong cross-section, which may be referred to as being substantially rectangular (e.g., defined at least in part by a major axis and a minor axis). As shown, the outer two conductors are adjacent to a larger exterior surface area than the middle conductor. As such, the outer two conductors may be able to dissipate (e.g., transfer) heat energy away from themselves more readily than the middle conductor. However, where the thermal conductivity of the medium or media surrounding the conductors, particularly the middle conductor, is increased, differences in heat transfer due to geometry may be reduced.

In the example of FIG. 5, where each of the outer conductors generates heat energy responsive to carrying current, the middle conductor may experience a lesser temperature gradient and, hence, driving force for heat transfer in a directions outwardly therefrom and toward each of the outer two conductors. In other words, the largest temperature gradient for the middle conductor may be in a direction orthogonal to that of its two neighbors. As an example, the jacket may be formed with a thermal conductivity that is greater in the y-direction than in the x-direction. In such an example, heat energy may be transferred away from the cable 500 along relatively planar surfaces (e.g., in the x,z-plane).

As an example, a cable may be configured with heat transfer characteristics that act to equilibrate or equalize temperatures experienced by conductors of the cable, for example, to provide for more balanced delivery of multiphase power. As an example, a cable may be configured with anisotropic thermal conductivities such that outer conductors transfer heat energy more readily outwardly toward a surface or surfaces and less so toward an inner conductor. For example, the jacket 540 of the cable 500 may have a thermal conductivity in the y-direction that is greater than a thermal conductivity in the x-direction. In such an example, heat transfer between conductors may be reduced in comparison to heat transfer from a conductor to an outer surface of the cable (e.g., in the z,x-plane). In such an example, the conductors may experience more uniform temperatures and thereby reduce unbalance where the conductors carry multiphase power to downhole equipment (e.g., consider length of cable, temperature internal and external, temperature variations over the length due to downhole environment, etc.).

As an example, a jacket may be a nitrile jacket made of NBR or, for example, another type of nitrile such as HNBR (e.g., hydrogenated NBR or highly saturated NBR), EPDM or a blend of two or more elastomers, etc. As an example, for strength, a thermoplastic jacket may include one or more of polyvinylidene difluoride (PVDF), ethylene tetrafluoroethylene (ETFE), fluorinated ethylene propylene (FEP), perfluoroalkoxy alkanes (PFA), PEEK, epitaxial co-crystaline alloy fluoroplastic (ECA fluoroplastic) or other materials (e.g., relatively neat, compounded with one or more fillers, etc.). As an example, cable conductor phases may be split out from each other with each phase encased in a solid metallic tube (e.g., optionally without a jacket).

Cable Armor 550 (e.g., optional)

As an example, cable armor, which may be optional, may include galvanized steel, stainless steel, alloys that include nickel and copper such as MONEL™ alloys, or other metal, metal alloy, or non-metal resistant to downhole conditions.

Cable Outer Coating 560

As shown in the example of FIG. 5, the cable 500 includes a cable outer coating 560. Such a coating may optionally be provided over cable armor, if present. As mentioned, a cable outer coating may help to reduce environmental impact, for example, by reducing presence of features that may pose potential risks for well fluid (e.g., oil, etc.) to be trapped inside the cable. For example, a cable outer coating may be a durable polymeric coating over an armor layer (e.g., or other layer such as a jacket layer) to help prevent well fluid from becoming trapped between overlapping armor layers (e.g., or inside the jacket if the cable does not have armor). In such an example, an outermost layer of a cable may be formed in a manner that has reduced surface roughness, reduced undulations, reduced corrugations, etc., for example, which may act to carry and/or entrap fluid, debris, etc. As an example, a cable outer coating may be relatively smooth and be resistant to swell (e.g., via gasses, liquids, etc.).

As an example, a layer disposed over an armor layer (e.g., over an outer surface of an armor layer) may be of sufficient robustness to reduce risk of damage, for example, during installation. In such an example, the layer may be resistant to abrasion from well fluid.

As an example, an outer cable coating may be provided that is mechanically strong, abrasion resistant, fluid and gas resistant, and capable of being processed into continuous relatively defect free layers.

As an example, a cable outer coating may be made of polyvinylidene fluoride (PVDF, KYNAR™ polymer (Arkema, Inc., King of Prussia, Pa.), TEDLAR™ polymer (E. I. du Pont de Nemours & Co., Wilmington, Del.), etc.). As an example, a cable outer coating may be made of PVDF modified with about 0.1 percent to about 10 percent by weight adducted maleic anhydride, for example, to facilitate bonding to a metallic armor or elastomer jacket (e.g. where armor is not employed).

As an example, as to a PVDF jacket, a copolymer of PVDF and hexafluoropropylene (HFP) may be used to increase coating flexibility and stress crack resistance (e.g., to form a PVDF-HFP jacket). As an example, a copolymer resin may be a commercially available resin (e.g., consider a KYNAR™ FLEX™ polyvinylidene fluoride-based resin). As an example, a fluoropolymer (e.g., consider a KYNAR™ FLEX™ polymer such as 2500, 2750, 2950, 2800, 2900, 2850, 3120, etc.) may form a surface that acts to increase contact angle of fluid. For example, surface tension effects may cause fluid at the surface to have a contact angle that acts to diminish wetting, which, in turn, may decrease mass transport of the fluid into the fluoropolymer.

As an example, a fluoropolymer may be provided as a powder and spray coated onto a surface of a cable. For example, consider spray coating a fluoropolymer onto armor of a cable. In such an example, the spray coating may fill gaps, voids, etc. in the armor. As an example, a spray process may include electrostatic coating. For example, powdered particles (e.g., or atomized liquid, etc.) may be projected towards a conductive layer of a cable (e.g., metallic armor) where the particles accelerated toward the conductive layer via electrostatic charge. As an example, an electrostatic coating process may include dipping a cable with a metallic armor into a tank of polymeric material that may be electrostatically charged such that, for example, ionic bonding of the polymeric material to the metallic armor creates an outermost layer with a thickness proportional to a residence time (e.g., with active charger).

As an example, a fluoropolymer may be provided in pellet form for input to an extruder that can extrude the fluoropolymer onto a cable (e.g., to form an outermost surface). As an example, a fluoropolymer may be provided in liquid/slurry form (e.g., about 20 percent solids by weight, etc.) and coated onto a cable via dipping, spraying, or other application technique.

As an example, armor may be protected by the fluoropolymer from corrosion by various chemicals and the outermost surface of the cable may be relatively smooth and free of features that may entrain fluid (e.g., as the cable is moved into and/or out of a well). As an example, a fluoropolymer may provide a cable with a relatively smooth surface that reduces friction and that has surface properties that reduce wetting by fluid(s). As an example, a fluoropolymer such as, for example, the KYNAR™ FLEX™ 2850 polymer, can include a coefficient of friction of about 0.19 (e.g., dynamic versus steel, ASTM D 1894 23 degrees C.). A fluoropolymer such as the KYNAR™ FLEX™ 2850 polymer may have a melting temperature in excess of about 150 degrees C. (e.g., about 155 degrees C. to about 160 degrees C.) and a thermal conductivity of about 1 to about 1.25 BTU-in/hr.ft² degrees F. (e.g., about 0.14 W/mK) (ASTM D433). As an example, a material may be added to a fluoropolymer to increase its thermal conductivity. For example, a composite material may include a fluoropolymer and a material with a thermal conductivity greater than the fluoropolymer (e.g., greater than about 0.14 W/mK).

As an example, for applications exceeding about 150 degrees C., coating or layer materials may include fluorinated polymers such as ETFE, FEP, PFA, or ECA or polyaryletherketones such as polyether ketone (PEK), PEEK and others. As an example, a high temperature fluoroplastic may be compounded with one or more fillers such as, for example, carbon fiber, carbon black, glass fiber, etc. to improve modulus and abrasion resistance.

As an example, a composite material can include one or more polymers and one or more fillers, which may be, for example, materials that can increase strength, increase abrasion resistance, increase thermal conductivity, alter electrical conductivity (e.g., insulators, etc.), etc. As an example, a composite material may include one or more of graphite, carbon black, carbon nanotubes, diamond, etc. where such one or more fillers may act to increase thermal conductivity (e.g., beyond that of the polymer(s) alone). As an example, a filler may be a ceramic (e.g., aluminum oxide, etc.), which may increase thermal conductivity.

As an example a cable may be deployed in a subsea operation, for example, to delivery multiphase power to an ESP. As an example, a cable may be deployed for transmission of power, for example, where voltages may be in excess of about 480 V and, for example, in excess of about 4 kV.

As an example, a nitrile material may be a nitrile rubber such as, for example, NBR, XNBR, HNBR, etc. Nitrile is defined as being a copolymer of butadiene and acrylonitrile (ACN). NBR is at times referred to as “Buna N”, which is derived from butadiene and natrium (sodium, a catalyst that may be used in the polymerization of butadiene) while the letter “N” stands for acrylonitrile.

As to NBR, butadiene can impart elasticity and flexibility as well as supply an unsaturated bond for crosslinking, vulcanization, etc. while acrylonitrile (ACN) can impart hardness, tensile strength, and abrasion resistance, as well as resistance to hydrocarbons. As an example, heat resistance may be improved through increased ACN content (e.g., which may be in a range from about 18 percent to about 45 percent).

FIG. 6 shows an example of a plot 600 that illustrates relationships with respect to ACN content, volume swell in ASTM Oil No. 3 (e.g., IRM 903 oil, petroleum distillates, hydrotreated heavy naphthenic), and the brittle point of the elastomer. As indicated in the plot 600, a reduction in ACN content tends to reduce high temperature properties, increase material swell, and reduce fluid resistance. As an example, to improve high temperature properties, a peroxide cure system and/or fillers may be used. Various nitrile compounds may exhibit suitable tensile strength as well as resistance to abrasion, tear and compression set.

As an example, carboxylated nitrile rubber compounds (XNBR) may provide better strength properties, especially abrasion resistance, when compared to NBR (e.g., without carboxylation). As an example, carboxylated nitriles may be produced by inclusion of carboxylic acid groups (e.g., as polymer groups during polymerization). In such an example, carboxylic acid groups can provide extra crosslinks (e.g., pseudo or ionic crosslinks) and thereby produce harder, tougher compounds with higher abrasion resistance, modulus, and tensile strength than standard nitriles.

As an example, HNBR includes so-called highly saturated hydrocarbons and acrylonitrile (ACN) where, for example, increased saturation is achieved via hydrogenation of unsaturated bonds. As an example, increased saturation can impart (e.g., improve) heat, chemical, and ozone resistance. As an example, ACN content of HNBR can impart toughness, as well as resistance to hydrocarbons. Where unsaturated butadiene segments exist (e.g., less than about 10 percent), such sites may facilitate peroxide curing and/or vulcanization. As an example, a peroxide-cured HNBR may exhibit improved thermal properties without further vulcanization (e.g., as with sulfur-cured nitriles).

As an example, various types of fluoroelastomers may be abbreviated as FKMs. FKM (FPM by ISO) is a designation for about 80 percent of fluoroelastomers as defined in ASTM D1418. FKMs may exhibit heat and fluid resistance. For example, in FKMs, bonds between carbon atoms of the polymer backbone and attached (pendant) fluorine atoms tend to be resistant to chain scission and relatively high fluorine-to-hydrogen ratios can provide stability (e.g., reduced risk of reactions or environmental breakdown). Further, FKMs tend to include a carbon backbone that is saturated (e.g., lacking covalent double bonds, which may be attack sites). Elastomers such as one or more of the VITON™ class of FKM elastomers (E. I. du Pont de Nemours & Co., Wilmington, Del.) may be used (e.g., VITON™ A, VITON™ B, VITON™ F, VITON™ GF, VITON™ GLT, VITON™ GFLT, etc.).

On the basis of their chemical composition various FKMs may be divided into the following types: Type 1 FKMs are composed of vinylidene fluoride (VDF) and hexafluoropropylene (HFP); Type 2 FKMs are composed of VDF, HFP, and tetrafluoroethylene (TFE); Type 3 FKMs are composed of VDF, HFP, TFE, perfluoromethylvinylether (PMVE); Type 4 FKMs are composed of propylene, TFE, and VDF; Type 5 FKMs are composed of VDF, HFP, TFE, PMVE, and ethylene. Other categories of polymers can include FFKM and FEPM.

As an example, a polyvinylidene fluoride (PVDF) may be a relatively non-reactive and thermoplastic fluoropolymer produced at least in part by polymerization of vinylidene difluoride. As an example, a PVDF may be melt processed, for example, depending on melting point (e.g., due to modifiers, fillers, etc.). As an example, a PVDF may have a density of about 1.78. As an example, a cable may include an outermost layer that includes repeating 1,1-difluoroethyl units. As an example, a material may include a co-polymer of PVDF and HFP (e.g., poly(vinylidene fluoride-co-hexafluoropropylene), which may be abbreviated as PVDF-HFP). As an example, a cable outer coating may include a PVDF-HFP copolymer.

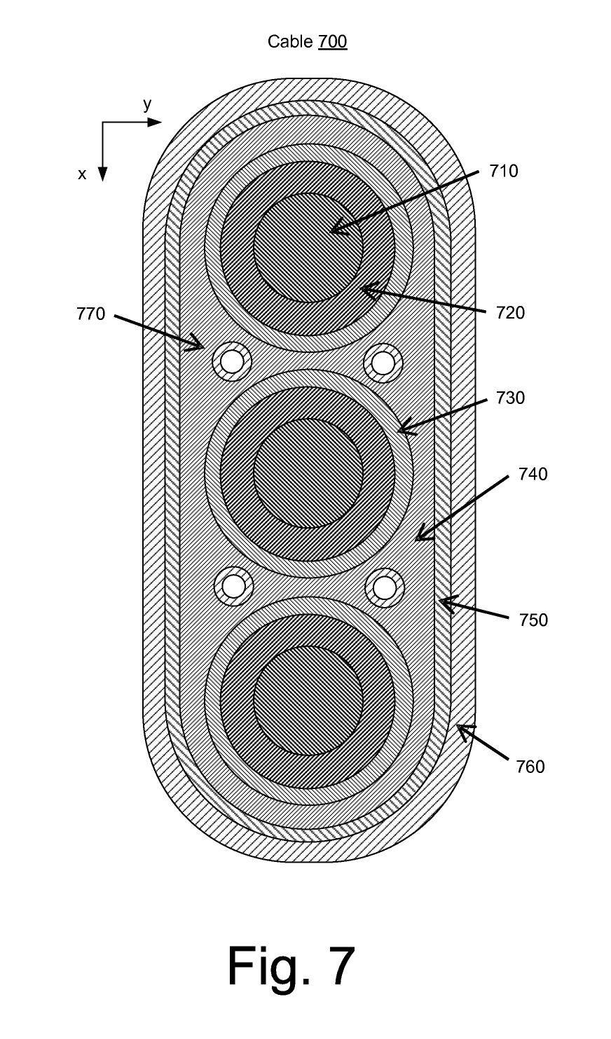

FIG. 7 shows an example of a cable 700 that includes conductors 710, insulation 720, barrier layers 730, a cable jacket 740, optional cable armor 750, an outer coating 760 and one or more tubes 770. As an example, a tube may be a capillary tube that includes a wall that defines a lumen through which fluid may flow. For example, the cable 700 may include one or more inlets for fluid and one or more outlets for fluid. In such an example, pressure may be applied to move fluid along at least a portion of the length of the cable 700 such that the fluid exits at least one outlet. As an example, a fluid may be a viscosity modifier, which may modify viscosity of a well fluid that can be pumped by a pump operatively coupled to the cable 700.

As an example, the cable 700 may optionally include one or more of conductor shields, insulation shields and conductive layers (see, e.g., the cable 500 of FIG. 5). As shown in the example of FIG. 7, the one or more tubes 770 may be disposed with the cable jacket 740. As an example, one or more tubes may be straight, spiraled, etc. within the cable jacket 740. As an example, one or more tubes may be disposed about a middle conductor, for example, to facilitate locating the one or more tubes in the cable 700 (e.g., prior to deposition of the cable jacket 740). As an example, the cable jacket 740 may be extruded over three conductors and associated layers thereon.

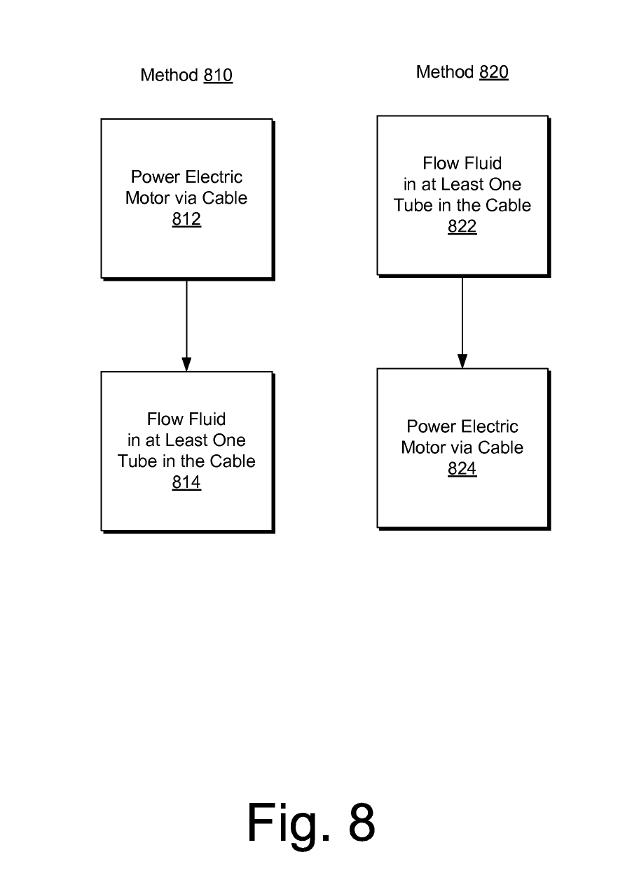

FIG. 8 shows an example of a method 810 and an example of a method 820. As shown, the method 810 includes a power block 812 for powering an electric motor via a cable and a flow block 814 for flowing fluid in at least one tube in the cable while the method 820 includes a flow block 822 for flowing fluid in at least one tube in a cable and a power block 824 for powering an electric motor via a cable. As an example, a method can include simultaneously powering an electric motor via a cable and flowing fluid in at least one tube of the cable.

As an example, a method can include pressurizing and/or depressurizing fluid in a tube or tubes, for example, to control equipment. For example, a piece of equipment may be operated pneumatically, hydraulically, etc. via pressure of fluid in one or more tubes. As an example, a valve may be controlled via pressure of fluid in one or more tubes, a shifting tool controlled via pressure of fluid in one or more tubes, a packer tool via pressure of fluid in one or more tubes, etc.

As an example, fluid in a tube may participate in heat transfer. For example, fluid flowing in a tube may transfer heat from one portion of a cable to another portion of a cable and, where the fluid exits the cable, the fluid may remove heat from the cable.

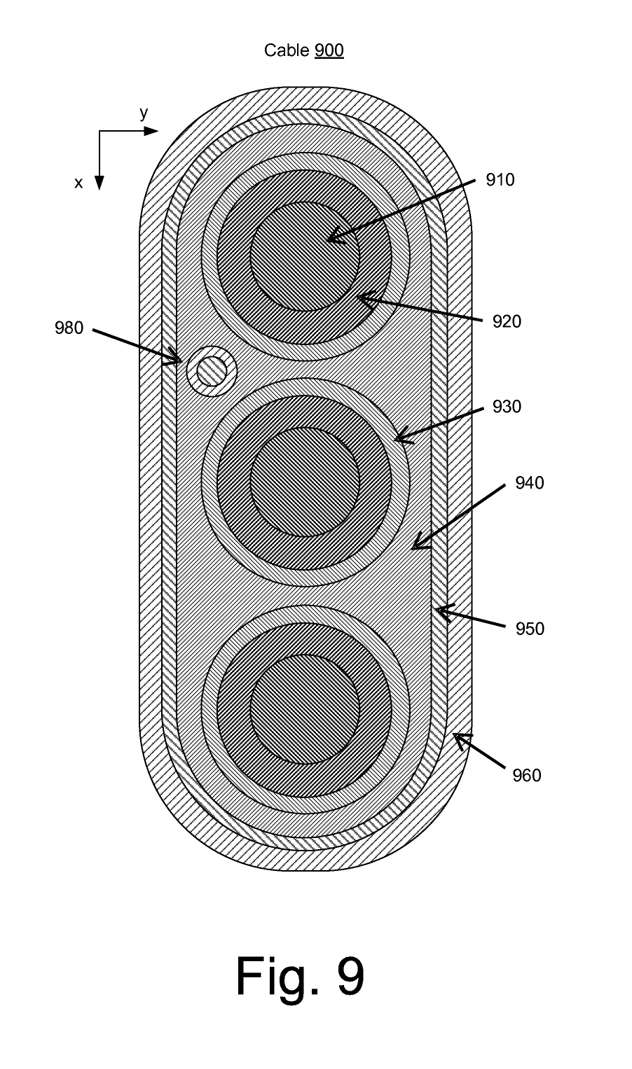

FIG. 9 shows an example of a cable 900 that includes conductors 910, insulation 920, barrier layers 930, a cable jacket 940, optional cable armor 950, an outer coating 960 and one or more fibers 980. As an example, a fiber may be a wire, wires, optical fiber, etc.

As an example, the cable 900 may optionally include one or more of conductor shields, insulation shields and conductive layers (see, e.g., the cable 500 of FIG. 5). As shown in the example of FIG. 9, the one or more fibers 980 may be disposed with the cable jacket 940. As an example, one or more fibers may be straight, spiraled, etc. within the cable jacket 940. As an example, one or more fibers may be disposed about a middle conductor, for example, to facilitate locating the one or more tubes in the cable 900 (e.g., prior to deposition of the cable jacket 940). As an example, the cable jacket 940 may be extruded over three conductors and associated layers thereon.

As an example, a fiber may be a ground wire. As an example, a fiber may be a signal wire. As an example, a fiber may operatively couple to an electric motor. As an example, a fiber may operatively couple to a sensor or sensors (e.g., a gauge or gauges) that may be operatively coupled to an electric motor. In such an example, the fiber may be a signal wire that can transmits signals to and/or from one or more sensors.

As an example, a cable may include fiber optic temperature sensors. As an example, a fiber optic temperature sensor may include a luminescing phosphor element that is excitable via transmission of energy via the fiber optic and where a decay rate of luminescence of the phosphor element depends on temperature. As an example, a cable may include a plurality of fiber optic temperature sensors that are individually excitable or collectively excitable and, for example, individually readable. In such an example, three optical fiber temperature sensors may be used to measure temperatures proximate to three conductors of a cable, for example, at a particular location along the cable. The measured temperature values may be indicative of heat generation, heat dissipation, heat transfer, etc. In such an example, the temperature values may be analyzed as obtain information germane to surrounding environment, surrounding fluid flow, current flow in a conductor, etc.

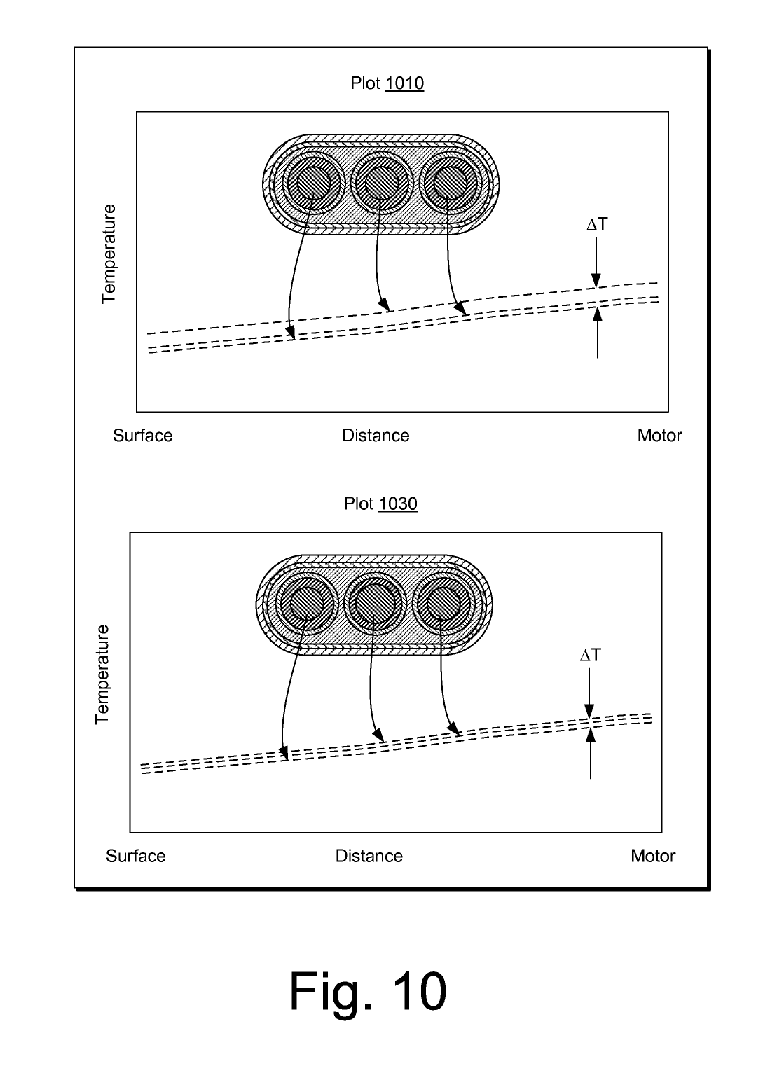

FIG. 10 shows an example plot 1010 and an example plot 1030 of conductor temperature versus distance (e.g., length) for two cables that are operatively coupled to a respective electric motor. As illustrated in the plot 1010, temperatures of conductors may be within a temperature range (e.g., ΔT). In such an example, the outer conductors (e.g., end conductors) may be at lesser temperatures than a middle conductor, for example, due to heat transfer. As shown, the conductors may be approximate equal in diameter (e.g., gauge).

In terms of AWG, a decrease of ten gauge numbers, for example, from No. 10 to 1/0, area and weight may be increased by approximately 10. As an example, resistance of a conductor may be estimated via an equation where resistivity multiplied by length is divided by cross-sectional area. As an example, a decrease of ten gauge number may reduce the resistance by a factor of approximately 10. As aluminum wire has a conductivity of approximately 61 percent of copper, an aluminum wire has nearly the same resistance as a copper wire 2 AWG sizes smaller, which has about 63 percent of the cross-sectional area.

In the plot 1030, the middle conductor is larger than the end conductors. In such an example, the temperature difference may be reduced when compared to the example of the plot 1010. For example, the middle conductor may be of lesser resistance than the outer conductors, which, in turn, may reduce heat generated within the middle conductor as power is conducted to power an electric motor.

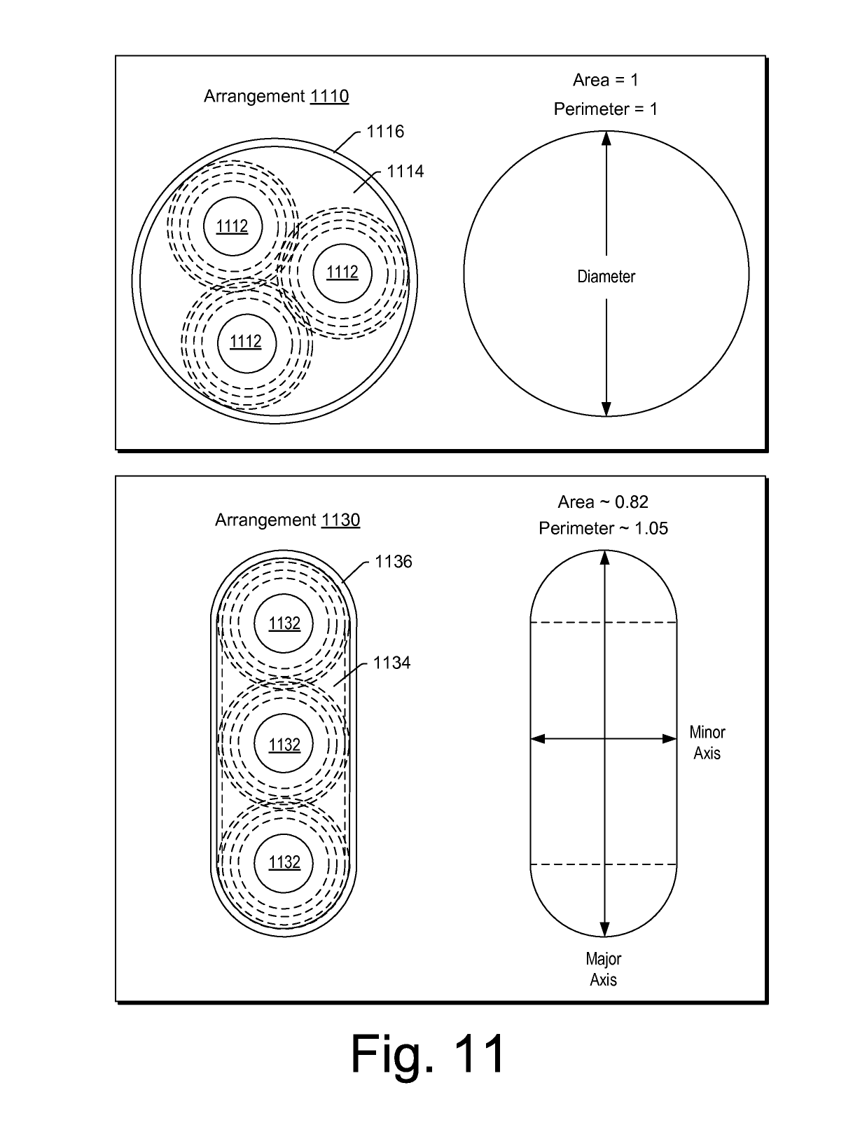

FIG. 11 shows an example of a geometric arrangement of components of a round cable 1110 and an example of a geometric arrangement of components of an oblong cable 1130. As shown the cable 1110 includes three conductors 1112, a polymeric layer 1114 and an outer layer 1116 and the oblong cable 1130 includes three conductors 1132, a polymeric layer 1134 (e.g., optionally a composite material with desirable heat transfer properties) and an optional outer polymeric layer 1136 (e.g., outer polymeric coat, which may be a composite material). In the examples of FIG. 11, a conductor may be surrounded by one or more optional layers, as generally illustrated via dashed lines. For example, as to the cable 1130, consider three 1 gauge conductors (e.g., a diameter of about 7.35 mm), each with a 2 mm layer and a 1 mm layer. In such an example, the polymeric layer 1134 may encapsulate the three 1 gauge conductors and their respective layers where, at ends, the polymeric layer 1134 may be about 1 mm thick. In such an example, an optional armor layer may be of a thickness of about 0.5 mm. In such an example, the optional outer polymeric layer 1136 (e.g., as covering armor) may be of a thickness of about 1 mm (e.g., a 1 mm layer).

As shown in FIG. 11, the cable 1110 includes a circular cross-sectional shape while the cable 1130 includes an oblong cross-sectional shape. In the example of FIG. 11, the cable 1110 with the circular cross-sectional shape has an area of unity and the cable 11130 with the oblong cross-sectional shape has area of about 0.82. As to perimeter, where the cable 1110 has a perimeter of unity, the cable 1130 has a perimeter of about 1.05. Thus, the cable 1130 has a smaller volume and a larger surface area when compared to the cable 1110. A smaller volume can provide for a smaller thermal mass and a larger surface area can provide for increased heat transfer. A smaller volume can provide for a smaller mass and, for example, less tensile stress on a cable that may be deployed a distance in a downhole environment (e.g., due to mass of the cable itself).

In the cable 1130, the conductors 1132 may be about 7.35 mm (e.g., about 1 AWG) in diameter with insulation of about 2 mm thickness, lead (Pb) of about 1 mm thickness, a jacket layer (e.g., the layer 1134) over the lead (Pb) of about 1 mm thickness at ends of the cable 1130, optional armor of about 0.5 mm thickness and an optional polymeric layer of about 1 mm thickness (e.g., the layer 1136 as an outer polymeric coat). As an example, the cable 1130 may be of a width of about 20 mm (e.g., about 0.8 inches) and a length of about 50 mm (e.g., about 2 inches), for example, about a 2.5 to 1 width to length ratio). As an example, a cable that includes three conductors for conduction of three phase power may include a width to length ratio of about 2 to 1 to about 5 to 1.

In the example of FIG. 11, the polymeric layer 1134 of the cable 1130 may be an outermost layer or, for example, the polymeric layer 1136 of the cable 1130 may be an outermost layer. As an example, the polymeric layer 1134 may include one or more of EPDM, nitrile, HNBR, fluorpolymer and cholorprene. As an example, a fluid resistant nitrile elastomer may be employed with low swell in water and hydrocarbon oil and resistance to wellbore gases. As an example, the polymeric layer 1134 may be an elastomer that is compounded with one or more fillers that increase thermal conductivity of the elastomer (e.g., optionally forming a composite material). As mentioned, improved thermal conductivity can help to reduce heat buildup on a middle conductor in an oblong cable, which may, for example, help balance voltage, reduce heat aging of one or more dielectric materials, etc.

As an example, the polymeric layer 1134 may include one or more thermoplastics such as one or more of PVDF, ETFE, FEP, PFA, PEEK and ECA. As an example, a thermoplastic or thermoplastics may optionally be compounded with one or more fillers, for example, to increase thermal conductivity (e.g., optionally forming a composite material).

As an example, the polymeric layer 1136 may be or include a fluoropolymer. The polymeric layer 1136 may be constructed of a material that can be mechanically strong, abrasion resistant, fluid and gas resistant, and capable of being processed into a continuous defect free layer (e.g., flow meltable material). As an example, the polymeric layer 1136 may include PVDF. As an example, the polymeric layer 1136 may include PVDF modified with about 0.1 percent to about 10 percent by weight adducted maleic anhydride, for example, to facilitate bonding to metallic armor or the polymeric layer 1134 (e.g., if the armor is not employed). As an example, the polymeric layer 1136 may include a copolymer of PVDF and HFP, which may increase coating flexibility and stress crack resistance (e.g., consider KYNAR™ FLEX™ material). As an example, for an application where temperature may exceed about 150 degrees C., a polymeric layer such as the layer 1136 may include one or more fluorinated polymers such as ETFE, FEP, PFA, or ECA or one or more polyaryletherketones (PAEKs) such as PEK, PEEK, etc. As an example, a material employed for use with temperatures in excess of about 150 degrees C. may include one or more fillers such as, for example, one or more of carbon fiber, carbon black, glass fiber, etc. (e.g., a filler that can increase modulus and abrasion resistance).

As an example, a cable may be formed with phases split out from each other where each phase is encased in solid metallic tubing.

As an example, a cable can include multiple conductors where each conductor can carry current of a phase of a multiphase power supply for a multiphase electric motor. In such an example, a conductor may be in a range from about 8 AWG (about 3.7 mm) to about 00 AWG (about 9.3 mm).

TABLE 1
Examples Components.

| Cable Component | Dimensions |
|---|---|
| Conductor (Cu) | 8 AWG to 00 AWG (3.7 mm to 9.3 mm) |
| Insulation | 58 mils to 130 mils (1.5 mm to 3.3 mm) |
| Lead (Pb) | 20 mils to 60 mils (0.5 mm to 1.5 mm) |
| Jacket over Lead (Pb) | 20 mils to 85 mils (0.5 mm to 2.2 mm) |
| Armor (e.g., optional) | 20 mils (0.5 mm) |
| Polymeric Coat (e.g., | 20 mils to 60 mils (0.5 mm to 1.5 mm) |
| optional) | |

In Table 1, where a cable has an oblong cross-sectional shape, the jacket over lead (Pb) layer may be, for example, of a thickness of about 20 mils to about 85 mils (e.g., about 0.5 mm to about 2.2 mm) at ends of the oblong cross-sectional shape and, for example, at various points along opposing sides of the oblong cross-sectional shape. For example, material forming the jacket over lead (Pb) layer may be thicker in regions between conductors (e.g., consider approximately triangular shaped regions).

A cable may be formed, at least in part, via an extrusion process. For example, a polymeric material maybe extruded over three conductors, which may include one or more layers about each of the conductors. In such an example, the polymeric material may have a thermal conductivity that is in excess of about 0.24 W/mK (e.g., optionally as a composite material). As an example, such a cable may include an outermost layer formed of a fluoropolymer, optionally as a composite material with one or more fillers. As an example, a cable may be formed with an outer armor layer where the cable is then coated with a polymeric coat, which may fill voids in the armor layer (e.g., between adjacent strips, etc.) and form a seal about the cable that can avoid intrusion of fluid.

As an example, a cable may include layers formed of solid materials. As an example, a cable may include one or more layers formed of folded material, wrapped material (e.g., tape), etc.

As an example, a cable may include conductors for delivery of power to a multiphase electric motor with a voltage range of about 3 kV to about 8 kV. Various conditions may arise during operation of such a motor that may increase generation of heat. As an example, a cable may carry power, at times, for example, with amperage of up to about 200 A or more. As an example, at a level of current of about 20 A to about 50 A, heat generation may increase within a cable. As to an environment about a cable, where a portion of a cable is in a gas environment, heat transfer from the cable to the gas environment can be less than heat transfer from the cable to a liquid environment. As an example, where fluid adjacent to a cable is flowing, heat transfer from the cable to the environment may be increased.

As to operational conditions, where an electric motor operates a pump, locking of the pump can cause current to increase and, where fluid flow past a cable may decrease, heat may build rapidly within the cable. As an example, locking may occur due to gas in one or more pump stages, bearing issues, particulate matter, etc.

As an example, a cable may carry current to power a multiphase electric motor or other piece of equipment (e.g., downhole equipment powerable by a cable). In such an example, consider current at about 150 A, which may result in a temperature rise in the cable of about 50 degrees C. (e.g., about 100 degrees F.). As an example, a cable may include a selection of materials and an arrangement of materials that enhance dissipation of heat generated via current flow in conductors of the cable. As an example, a cable with an arrangement such as that of the cable 1130 of FIG. 11 may operate at a temperature that is about 5 degrees C. or lower than a cable with an arrangement such as that of the cable 1110. As an example, a cable with an arrangement of the cable 1130 can include a polymeric outer layer (e.g., optionally a composite material).

In a cable with an arrangement such as the cable 1110 of FIG. 11, conductors may be of approximately the same temperature at a given cross-section; whereas, in a cable with an arrangement such as the cable 1130 of FIG. 11, the middle conductor may operate at a slightly higher temperature in comparison to the end conductors (e.g., due to heat transfer). As mentioned, as an example, the middle conductor may be larger than the end conductors such that resistance and heat generation may be lesser in the middle conductor (see, e.g., the plot 1010 of FIG. 10).

As an example, an electric submersible pump system can include a shaft; a power cable connector for receipt of multiphase power; a multiphase electric motor configured to receive power via the power cable connector for rotatably driving the shaft; a pump operatively coupled to the shaft; and a power cable that includes a connector for connection to the power cable connector, a row multiphase conductors, a jacket surrounding the row of multiphase conductors that includes a polymer, and an outer coating that includes a fluoropolymer.

As an example, an electric submersible pump system can include a cable with a jacket that includes a thermal conductivity greater than about 0.24 W/mK. As an example, such a jacket can include a filler material disposed in a matrix that includes the polymer. As an example, a filler material may include a thermal conductivity in excess of about 0.24 W/mK. As an example, a jacket may include anisotropic thermal conductivities. As an example, a filler may include a metal, alloy, or other material, for example, as particles, fibers, etc. As an example, where a jacket is extruded, an extrusion process may provide for orientation of orientable filler material, for example, to provide spacing of filler material (e.g., as in flow layers), direction orientation (e.g., as to an axis of a filler particle, fiber, etc.).

As an example, a cable may include armor and, for example, an outer coating may be disposed over the armor, for example, to avoid crevices, nooks, etc. where fluid may accumulate.

As an example, a row of multiphase conductors may include three conductors for delivery of three phase power to a multiphase electric motor. In such an example, the three conductors may be a middle conductor and two outer conductors.

As an example, a power cable can include a major axis dimension and a minor axis dimension; a minor axis dimension to major axis dimension ratio in a range of 2 to 1 to 5 to 1; multiphase conductors spaced along the major axis dimension, a jacket surrounding the multiphase conductors that includes a polymer, and an outer coating that includes a fluoropolymer. In such an example, the major axis dimension may be less than approximately 5 cm (e.g., less than 5 cm).

As an example, in a power cable, multiphase conductors can include a middle conductor and two end conductors where the middle conductor includes a larger cross-sectional area than the two end conductors.

As an example, a jacket of a power cable can include a thermal conductivity greater than about 0.24 W/mK. As an example, an outer coating of such a power cable can include poly(vinylidene fluoride-co-hexafluoropropylene) (PVDF-HFP), ethylene tetrafluoroethylene (ETFE) or poly(vinylidene fluoride-co-hexafluoropropylene) (PVDF-HFP) and ethylene tetrafluoroethylene (ETFE). As an example, an outer coating of a power cable can include a composite material that includes carbon fiber.

As an example, a method can include providing an electric submersible pump system in a downhole environment where the electric submersible pump system includes a shaft; a power cable connector for receipt of multiphase power; a multiphase electric motor that receives power via the power cable connector for rotatably driving the shaft; a pump operatively coupled to the shaft; and a power cable connected to the power cable connector where the power cable includes a row multiphase conductors, a jacket surrounding the row of multiphase conductors that includes a polymer, and an outer coating that includes a fluoropolymer; supplying multiphase power to the power cable to energize the multiphase electric motor to thereby pump downhole fluid from the downhole environment to a surface environment; generating heat energy in the row of multiphase conductors responsive to the supplying of multiphase power; dissipating heat energy from the row of multiphase conductors via the jacket; and removing at least the power cable from the downhole environment to the surface environment without entraining downhole fluid in the power cable.

In such an example, the jacket may include a thermal conductivity greater than 0.24 W/mK such that the dissipating acts to maintain balance across the multiple phases. As an example, the thermal conductivity may be greater than about 0.25 W/mK. As an example, the thermal conductivity may be greater than about 0.3 W/mK (e.g., via addition of one or more fillers that form a composite material with one or more polymers).

As an example, a method may include measuring unbalance at a wye point of the multiphase electric motor. As an example, such a method may include estimating temperature differences with respect to conductors of a row of multiphase conductors based at least in part on the measuring unbalance. For example, a model may be built that models cable characteristics, power supply, efficiency, etc. such that unbalance may be an input (e.g., optionally as to individual conductors with respect to each other) that can, in turn, determine if a conductor has a temperature greater than its neighbors that may account for at least a portion of the unbalance.

As an example, an outer coating of a power cable may include a smooth surface such that upon removing the power cable from a downhole environment to a surface environment, the power cable does not entrain downhole fluid in the power cable.

As an example, one or more methods described herein may include associated computer-readable storage media (CRM) blocks. Such blocks can include instructions suitable for execution by one or more processors (or cores) to instruct a computing device or system to perform one or more actions.

According to an embodiment, one or more computer-readable media may include computer-executable instructions to instruct a computing system to output information for controlling a process. For example, such instructions may provide for output to sensing process, an injection process, drilling process, an extraction process, an extrusion process, a pumping process, a heating process, etc.

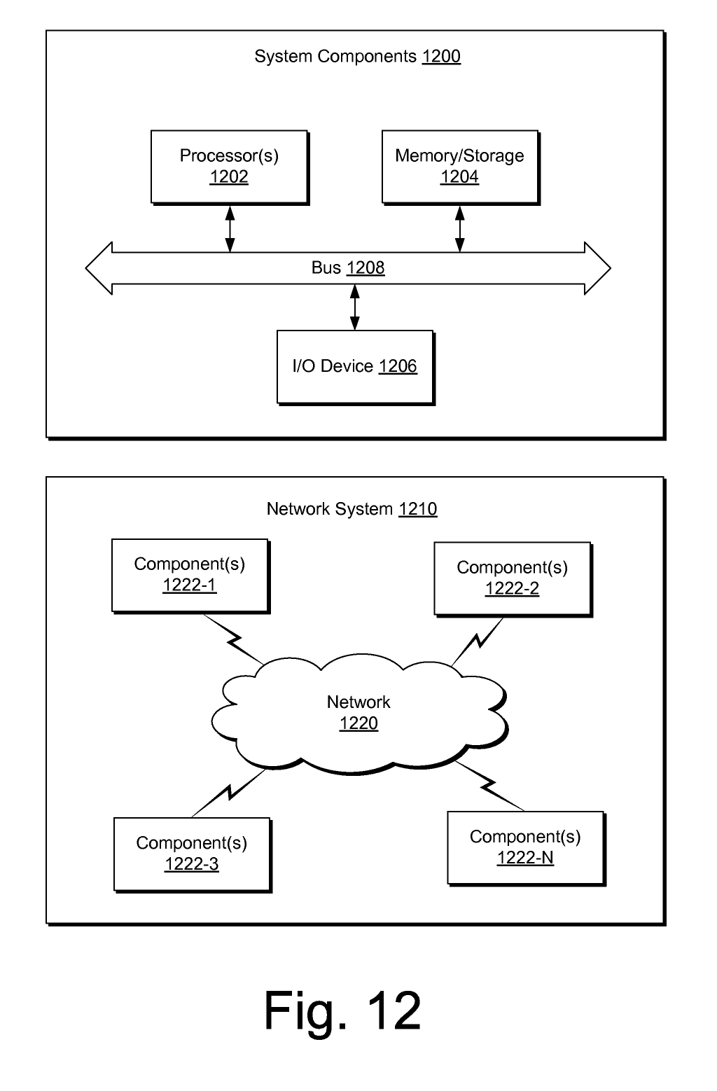

FIG. 12 shows components of a computing system 1200 and a networked system 1210. The system 1200 includes one or more processors 1202, memory and/or storage components 1204, one or more input and/or output devices 1206 and a bus 1208. According to an embodiment, instructions may be stored in one or more computer-readable media (e.g., memory/storage components 1204). Such instructions may be read by one or more processors (e.g., the processor(s) 1202) via a communication bus (e.g., the bus 1208), which may be wired or wireless. The one or more processors may execute such instructions to implement (wholly or in part) one or more attributes (e.g., as part of a method). A user may view output from and interact with a process via an I/O device (e.g., the device 1206). According to an embodiment, a computer-readable medium may be a storage component such as a physical memory storage device, for example, a chip, a chip on a package, a memory card, etc.

According to an embodiment, components may be distributed, such as in the network system 1210. The network system 1210 includes components 1222-1, 1222-2, 1222-3, . . . , 1222-N. For example, the components 1222-1 may include the processor(s) 1202 while the component(s) 1222-3 may include memory accessible by the processor(s) 602. Further, the component(s) 1202-2 may include an I/O device for display and optionally interaction with a method. The network may be or include the Internet, an intranet, a cellular network, a satellite network, etc.

### CONCLUSION

Although only a few examples have been described in detail above, those skilled in the art will readily appreciate that many modifications are possible in the examples. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words “means for” together with an associated function.

What is claimed is:

1. An electric submersible pump system comprising:
a shaft;
a power cable connector for receipt of multiphase power;
a multiphase electric motor configured to receive power via the power cable connector for rotatably driving the shaft;
a pump operatively coupled to the shaft; and
a power cable that comprises
a connector for connection to the power cable connector,
a row multiphase conductors,
a jacket surrounding the row of multiphase conductors that comprises a polymer, and
an outer coating that comprises a fluoropolymer.

2. The electric submersible pump system of claim 1 wherein the jacket comprises a thermal conductivity greater than about 0.24 W/mK.

3. The electric submersible pump system of claim 2 wherein the jacket comprises a filler material disposed in a matrix that comprises the polymer.

4. The electric submersible pumps system of claim 3 wherein the filler material comprises a thermal conductivity in excess of about 0.24 W/mK.

5. The electric submersible pump system of claim 1 wherein the jacket comprises anisotropic thermal conductivities.

6. The electric submersible pump system of claim 1 wherein the power cable further comprises armor.

7. The electric submersible pump system of claim 6 wherein the outer coating is disposed over the armor.

8. The electric submersible pump system of claim 1 wherein the row of multiphase conductors comprises three conductors for delivery of three phase power to the multiphase electric motor.

9. The electric submersible pump system of claim 8 wherein the three conductors comprise a middle conductor and two outer conductors.

10. A power cable comprising:
a major axis dimension and a minor axis dimension;
a minor axis dimension to major axis dimension ratio in a range of 2 to 1 to 5 to 1;
multiphase conductors spaced along the major axis dimension;
a jacket surrounding the multiphase conductors that comprises a polymer; and
an outer coating that comprises a fluoropolymer.

11. The power cable of claim 10 wherein the multiphase conductors comprise a middle conductor and two end conductors wherein the middle conductor comprises a larger cross-sectional area than the two end conductors.

12. The power cable of claim 10 wherein the jacket comprises a thermal conductivity greater than about 0.24 W/mK.

13. The power cable of claim 10 wherein the outer coating comprises poly(vinylidene fluoride-co-hexafluoropropylene) (PVDF-HFP), ethylene tetrafluoroethylene (ETFE) or poly(vinylidene fluoride-co-hexafluoropropylene) (PVDF-HFP) and ethylene tetrafluoroethylene (ETFE).

14. The power cable of claim 10 wherein the outer coating comprises a composite material that comprises carbon fiber.

15. The power cable of claim 10 wherein the major axis dimension is less than approximately 5 cm.

16. A method comprising:
providing an electric submersible pump system in a downhole environment wherein the electric submersible pump system comprises a shaft; a power cable connector for receipt of multiphase power; a multiphase electric motor that receives power via the power cable connector for rotatably driving the shaft; a pump operatively coupled to the shaft; and a power cable connected to the power cable connector wherein the power cable comprises a row multiphase conductors, a jacket surrounding the row of multiphase conductors that comprises a polymer, and an outer coating that comprises a fluoropolymer;
supplying multiphase power to the power cable to energize the multiphase electric motor to thereby pump downhole fluid from the downhole environment to a surface environment;
generating heat energy in the row of multiphase conductors responsive to the supplying of multiphase power;
dissipating heat energy from the row of multiphase conductors via the jacket; and
removing at least the power cable from the downhole environment to the surface environment without entraining downhole fluid in the power cable.

17. The method of claim 16 wherein the jacket comprises a thermal conductivity greater than 0.24 W/mK and wherein the dissipating acts to maintain balance across the multiple phases.

18. The method of claim 17 further comprising measuring unbalance at a wye point of the multiphase electric motor.

19. The method of claim 18 further comprising estimating temperature differences with respect to the conductors of the row of multiphase conductors based at least in part on the measuring unbalance.

20. The method of claim 16 wherein the outer coating of the power cable comprises a smooth surface such that the removing at least the power cable from the downhole environment to the surface environment does not entrain downhole fluid in the power cable.
